(19) United States
(12) Patent Application Publication
(10) Pub. No.: US 2004/0000292 A1
(43) Pub. Date: Jan. 1, 2004

(54) Device for forming a mixture in the intake tract of internal combustion engines

(75) Inventors: Eckhard Bodenhausen, Steinheim (DE); Franco Zeleny, Besigheim (DE); Horst Kirschner, Brackenheim-Hausen (DE)

Correspondence Address: KENYON & KENYON, ONE BROADWAY, NEW YORK, NY, 10004, US

(73) Assignee: Robert Bosch GmbH

(21) Appl. No.: 10/607,335

(22) Filed: Jun. 26, 2003

(30) Foreign Application Priority Data
Sep. 2, 2002 (DE) 102 40 394.5-13
Jun. 26, 2002 (DE) 102 28 532.2-13

(51) Int. Cl. F02M 55/02

(52) U.S. Cl. 123/456

(57) ABSTRACT

An intake tract for an internal combustion engine, including a number of divided intake line sections corresponding to the number of cylinders in the internal combustion engine. These intake line sections are mountable on the internal combustion engine in the intake area. A fuel distributor and at least one injector supply fuel to the combustion chambers of the internal combustion engine. At least one injector unit, the mounting locations thereof as well as fuel supply components and their contacting elements are integrated into a cover element to be joined to a lower-shell-shaped intake manifold section.

### FIELD OF THE INVENTION

In internal combustion engines used in motor vehicles, fuel is injected by fuel injection valves or fuel injectors that are located in the cylinder head area of the internal combustion engine. The fuel supply lines or fuel distributors, through which the fuel is supplied, are usually also located on the cylinder head of the internal combustion engine.

### BACKGROUND INFORMATION

In multiple-cylinder internal combustion engines, the intake manifold accommodating a throttle device downstream from the throttle valve splits into multiple line branches that are connected to the internal combustion engine on the intake side thereof. The number of line branches is equal to the number of internal combustion engine cylinders to be supplied with an air/fuel mixture. In the case of fuel injection systems based on the single injection principle, injectors, through which the fuel is supplied to the injectors assigned to each of the intake line branches of the intake manifold, are provided upstream from the intake valves of the internal combustion engine. For this purpose, the injectors corresponding to the number of cylinders are supplied with fuel via a fuel distributor, which can be made of either a plastic material or a metallic material.

The fuel distributors ordinarily include a plurality of individual components, some of which are already premounted as function groups. Individual components include, e.g., the distributor pipe, injector unit, retaining clips and secondary wiring harnesses for actuating the individual injectors.

The intake line branches of the intake manifold assigned to the individual combustion chambers of the internal combustion engine can be made of plastic in a shell-shaped construction. The plastic material used can be fiberglass-reinforced. The upper and lower shells of the intake manifold can be welded along a parting line; the injectors, or the complete fuel distributor, are mounted in the upper shell of the intake manifold. The injectors are electrically actuated via a secondary wiring harness on the fuel distributor, which, in turn, must be connected to the main wiring harness of the internal combustion engine. External influences such as heat, engine washes, etc., stress not only the secondary wiring harness, but also to a not inconsiderable extent the remaining parts of the fuel distributor.

### SUMMARY

An object of the present invention makes use of the shell-shaped construction in the manufacture of an intake manifold section by modifying the upper shell of the intake manifold, which, in the case of four-cylinder internal combustion engines, for example, is injection-molded in a single piece, so that both the fuel distributor (gasoline supply system) and the injectors may be accommodated in an injection-molded geometry provided for this purpose. An electrical contact rail, which is manufactured as a single piece, may be positioned in the geometry provided for this purpose after the injectors have been installed and integrally joined to the upper intake manifold shell geometry by friction welding. Following a leak test and an electrical continuity test, this prefabricated function group containing the upper shell of the intake manifold may be placed on the lower shell of the intake manifold and joined thereto along a parting line by vibration welding.

The vibration welding of the upper and lower shells of the intake manifold joins together the complete intake manifold, on which an intake manifold flange may be formed. The front section of the injector mounted on the upper shell of the intake manifold extends slightly out of the assembled intake manifold group and may be provided with a sealing ring. While mounting the vibration-welded intake manifold onto the cylinder head of an internal combustion engine, the lower end of an injector is inserted, along with the O-ring accommodated thereon, into the cylinder head to which the intake manifold may be screwed via flange holes. Channels penetrating the cylinder head and connected to both the mounting brackets of the injectors and the combustion air supply line merge upstream from the intake valves of the combustion chambers of the internal combustion engine, where they bring the combustion air/fuel mixture together.

This may make it possible to avoid mounting a function group containing defective components onto the internal combustion engine. In addition, the previously used secondary wiring harnesses are replaceable by a contact rail on the cover element having the integrated fuel distributor and integrated injectors. A contact rail allows the injectors, which are mounted in the bracket area of the cover element, to be actuated, the electrical contacts being encapsulated to the outside, i.e., in the direction of the internal combustion engine.

According to an embodiment of the present invention, the electrical points of contact within the contact rail may be encapsulated. The previous individual components, for example, retaining clips, secondary wiring harnesses for actuating or connecting the fuel distributor to the intake tract may be unnecessary by the integration according to the present invention into the cover element produced as an injection-molded component; in addition, the previously used retaining clips and—as mentioned above—the secondary wiring harnesses may be eliminated. For example, if the intake manifolds and the corresponding intake line branches are manufactured as injection-molded parts—in a quantity corresponding to the number of cylinders in the internal combustion engine—the cover elements, i.e., the upper shells for all lower shells of the intake manifold, are injection-moldable as a single piece. This one-piece cover element, which covers a number of intake manifold sections designed as lower shells, is weldable along a parting line to the intake manifold sections forming the lower shell of the cover element in the intake tract.

### BRIEF DESCRIPTION OF THE DRAWINGS

FIG. 1 shows an example embodiment of a fuel distributor for an internal combustion engine in an embodiment according to the related art.

FIG. 2 shows a perspective view of a cover element having an integrated fuel feeder line, fuel distributor, fuel intake line and contact rail according to an example embodiment of the present invention.

FIG. 3 shows a sectional representation of the cover element according to FIG. 1 in the area of a bracket for an injector, as well as a sectional view of the intake manifold section.

### DETAILED DESCRIPTION

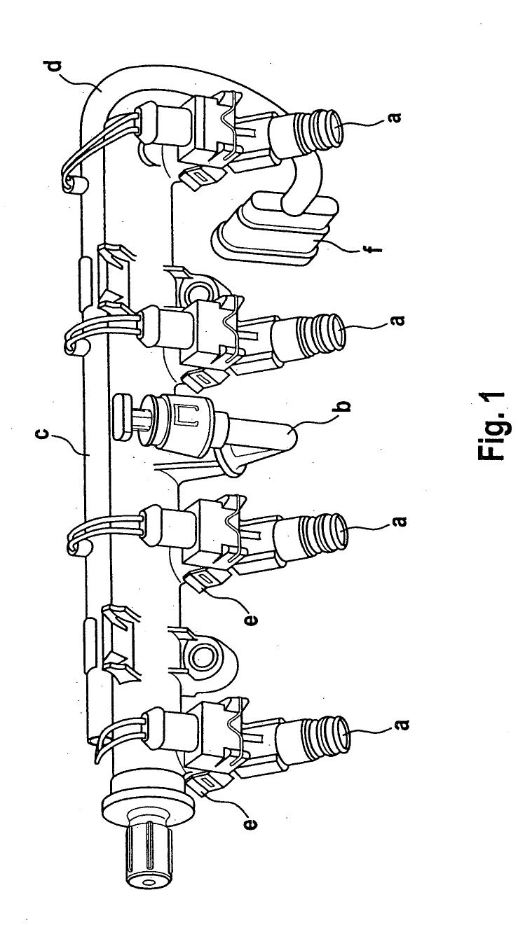

FIG. 1 shows an example embodiment of a fuel distributor for an internal combustion engine.

The representation in FIG. 1 shows a fuel distributor on which—when used in a four-cylinder internal combustion engine—four injectors branch off from a distributor pipe c. Injectors a are used to inject fuel into the intake channels of the combustion chambers of the internal combustion engine, the fuel being mixed with the combustion air conducted thereto and entering the combustion chamber of the internal combustion engine through open intake valves. Individual injectors a are attached by retaining clips e to retaining members that are provided on distributor pipe c. Each of injectors a is actuated by trigger lines branching off from a secondary wiring harness d. The individual trigger lines for injectors a run more or less without protection outside the distributor pipe and are almost directly exposed to temperature fluctuations, weather influences and engine washes. A connector f connecting the secondary wiring harness, which contains the trigger lines for injectors a, to the main wiring harness of the internal combustion engine is mounted on secondary wiring harness d. The fuel intake line, through which fuel enters plastic distributor pipe c, is identified by reference letter b. Bracket elements, which may be used to screw on distributor pipe c in the cylinder head area of an internal combustion engine, are injection-molded in the lower area of the distributor pipe. The example embodiment of a fuel distributor illustrated in FIG. 1 includes a plurality of individual parts that may be assembled into a premountable function group and subsequently attached in the cylinder head area of an internal combustion engine.

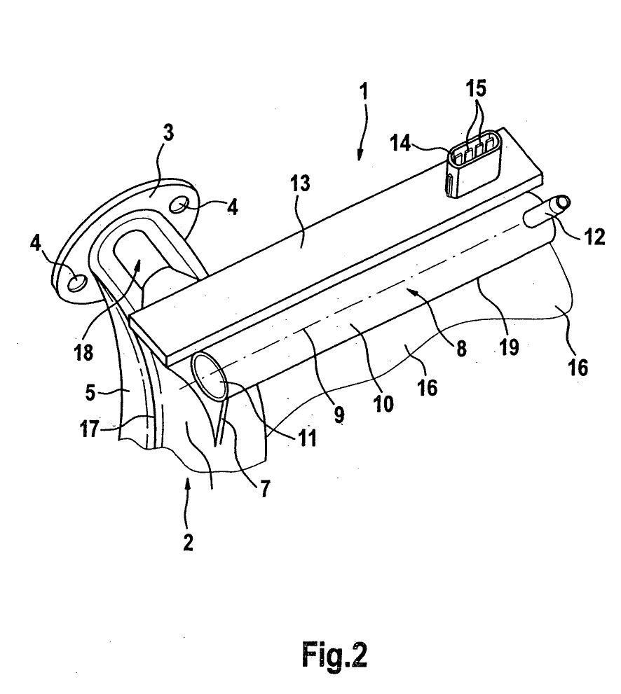

FIG. 2 shows a perspective view of a cover element having an integrated fuel distributor, fuel intake line and contact rail, according to an example embodiment of the present invention.

An intake tract 1 of an internal combustion engine includes a number of intake line branches 2 corresponding to the number of cylinders in the internal combustion engine. Individual intake line branches 2 may each include a mounting flange 3 that has one or more holes 4 for attaching mounting flange 3 to an internal combustion engine on the intake side. Individual intake line branches 2 representing intake tract 1 may be manufactured as, e.g., plastic parts or diecast aluminum parts. If intake line branches 2 are used in a four-cylinder internal combustion engine, intake tract 1 includes four individual intake line branches 2, each of which is assigned to the intake side of one of the four cylinders of the internal combustion engine. If used in a 6-, 8- or 10- or even 12-cylinder internal combustion engine, intake line branches 2 are provided on the internal combustion engine—according to the position of the cylinder banks—in the intake areas of the combustion chambers. In the interest of clarity, the representation according to FIG. 2 shows a detailed view of only one intake line 2. Intake line branch 2 includes an intake manifold section 5 designed in the form of a lower shell, which is provided with a cover element 6 having integrated additional function groups that are described in greater detail below. Cover element 6 and lower-shell-shaped intake manifold section 5 are welded together and sealed in the area of a parting line 17.

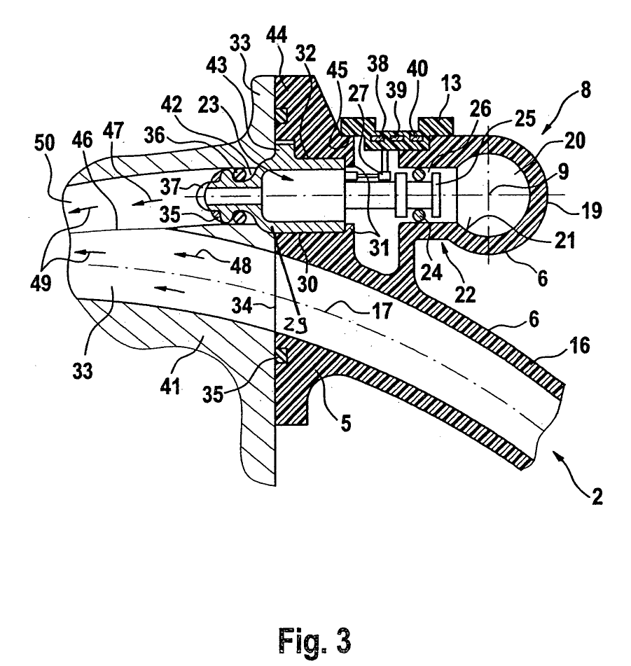

Cover element 6 manufactured as an injection-molded component made of a plastic material includes an injection-molded rib structure 7 which, as shown in FIG. 1, is used as a bracket for a tubular fuel distributor 8. Fuel distributor 8, in turn, is designed as an injection-molded component integrated into cover element 6 and includes a locking element 11 and a fuel inlet 12, which is injection-molded onto jacket surface 10 of fuel distributor 8. Fuel distributor pipe 8 extends largely parallel to the longitudinal axis of the multiple-cylinder internal combustion engine. Jacket surface 10 of fuel distributor pipe 8 surrounds a cavity that is filled with fuel via fuel inlet 12 on the outside of fuel distributor pipe 8. A contact rail 13, which includes a central connector 14, extends parallel to longitudinal axis 9 of fuel distributor pipe 8. Individual contact strips pass through the interior of contact rail 13 (see illustration according to FIG. 3, reference numbers 38, 39, 40). The individual contact strips not illustrated in FIG. 2 are actuated via contact tabs 15 of central connector 14. The contact strips integrated into the interior of contact rail 13 (see illustration according to FIG. 2) actuate the individual injector units that are assigned to intake line branches 2 and are integrated into cover element 6 at the mounting positions identified by reference number 18 in FIG. 2.

In addition to the mounting positions identified by reference number 18 for premounted injection units, cover element 6 also includes cover sections 16 that are designed as a cohesive structure. Individual cover sections 16 extend below contact rail 13 and below tubular fuel distributor 8 made of a plastic material. Cover sections 16 of cover element 6 cover additional lower-shell-shaped intake manifold sections 5 that are provided according to the number of combustion chambers to be supplied with an air/fuel mixture. Multiple fuel inlets 12 may also discharge at outer wall 19 of fuel distributor pipe 8, depending on the length and accommodatable fuel volume dependent thereon.

The illustration according to FIG. 3 shows a sectional view of the cover element illustrated in FIG. 2 in the area of a bracket for an injector unit, along with a sectional view of an intake manifold section.

The illustration in FIG. 3 shows that intake line branch 2 is formed by a lower-shell-shaped intake manifold section 5 and a cover section 16 designed as an injection-molded plastic part 6. Cover section 16 of cover element 6 is welded to lower-shell-shaped intake manifold section 5 along a parting line identified by reference number 17. If lower-shell-shaped intake manifold section 5 and cover section 16 of cover element 6 are manufactured as injection-molded plastic parts, structural components 5 and 6 may be joined by welding them along parting line 17, for which purpose the plastic material has only to be heated in the area of the parting line.

As also shown by the illustration according to FIG. 3, tubular fuel distributor 8 is directly integrated into cover element 6 and injection-molded cover section 16. For this purpose, a fuel distributor pipe 8 is injection-molded onto cover element 6, extending parallel to the internal combustion engine along its longitudinal axis 9 which, in this case, is perpendicular to the drawing plane. Cavity 20 in tubular fuel distributor pipe 8 is limited by an inner wall 21. The outer wall of fuel distributor 8 is identified by reference number 19. The material thickness of the wall of fuel distributor pipe 8 is uniform over a large portion of the circumference of fuel distributor pipe 8, except for the material thickness in the area of an opening 26 and a support for contact rail 13 previously addressed in FIG. 2.

Cavity 20 enclosed by fuel distributor pipe 8 is filled with fuel via fuel intake line 12 shown in FIG. 2. The fuel enters individual injector units 23, which are mounted according to the spacing of the combustion chambers, i.e., the cylinders of the internal combustion engine, independently of its ignition principle, through openings 26, which are provided along the longitudinal extension of fuel distributor pipe 8 parallel to longitudinal axis 9.

Openings 26 are used to supply fuel to individual injectors 23 integrated into cover element 26; openings 26 also serve as a first mounting location 22 for injector units 23 integrated into cover element 6.

Individual premounted injector units 23 include a sleeve-like body 29 surrounding injector 23. Sleeve-like body 29 surrounding injector 23 encloses the valve body of injector 23 and includes a bead-like swelling assigned to valve opening 37 of injector 23. A circumferential groove 42, into which an annular sealing element 36 made of an elastic material is inserted, is provided between the swelling and the further section of sleeve 29 surrounding the valve body of injector 23. Sleeve 29 surrounding the valve body of injector 23 further includes a locking cam 43. The outer surface of sleeve 29 accommodating the valve body of injector 23 forms a contact area 30 for premounted injector unit 23 within a second mounting location, identified by reference number 28, for injector 23 in cover element 6.

A retaining member 44 is located in the area of second mounting location 28 for premounted injector unit 23. Retaining member 44 includes a second collar surface 32 against which rests a locking cam 43 provided on sleeve 29 in positionally accurate alignment with injector unit 23. Retaining member 44 also includes a first collar surface 31 against which rests an annular end face of sleeve 29. A supporting surface 45 against which rests contact rail 13 illustrated in the sectional view according to FIG. 2 is provided on retaining member 44.

Contact rail 13 is used to actuate individual injector units 23 integrated into cover element 6. Contact rail 13 is positioned on above-mentioned supporting surface 45 on retaining member 44 as well as on an area of injection-molded distributor pipe 8 serving as a supporting surface. The sectional view of contact rail 13 illustrated in FIG. 2 shows that individual contact strips 38, 39, 40 are integrated into the interior of contact rail 13. Contact strips 38, 39, 40 of contact rail 13 are in contact with contact tabs 15 in central connector 14 of contact rail 13, enabling individual injectors 23 accommodated in cover element 6 to be electrically actuated without having to use individual secondary wiring harnesses assigned to individual injectors 23. The electrical contacting of contact rail 13, using a contact connector 14 containing contact tabs 15, may makes the provision of secondary wiring harnesses unnecessary and encapsulates the electrical drive against external weather and temperature influences. Individual contacting elements 27, which are used to electrically actuate individual injectors 23, are provided below individual contact strips 38, 39, 40 running parallel to longitudinal axis 9 of fuel distributor pipe 8 in contact rail 13. The electrical contacts of the injectors are encapsulated to the outside by contact rail 13, which forms a cover. Contacting elements 27 are provided in a cavity positioned on cover element 6 between first mounting location 22 and second mounting location 28 for premounted injector units 23.

Premounted injector unit 23 is locked in place in integrated cover element 6 by assembling the upper and lower shells and subsequently locking the intake manifold in place on cylinder head 41 of the internal combustion engine, regardless of its ignition principle. Injectors 23 are inserted into first mounting location 22 or second mounting location 28. Sealing element 36 made of an elastic material and inserted into circumferential groove 42 of sleeve 29 forms a seal to the outside. As illustrated in FIG. 3, a collar 25 is provided on injector 23. An annular sealing element 24 that seals opening 26, through which fuel flows to injector 23 from cavity 20 of fuel distributor pipe 8, is located between collar 25 and a further collar on injector 23 diametrically opposed thereto. The electrical point of contact between contact rail 13 and injector 23 or individually assigned contacting elements 27 is thus sealed against penetrating fuel.

Before cover element 6 integrating the additional functions is mounted on lower-shell-shaped intake manifold section 5, individual injector units 23 are mounted in cover element 6. Individual injectors 23 are mounted by inserting them into opening 26 in distributor pipe 8 representing a first mounting location 22 according to their assembly positions. The injectors are sealed therein by an elastic ring element 24 functioning as a sealing element. Sleeve 29 surrounding the body of injector 23 is positioned in a second mounting location 28 of cover element 6. After injector member 23 is inserted into cover element 6, retaining member 44 is mounted. First collar section 31 on retaining member 44 and corresponding collar section 31 on cover element 6 form an annular stop surface for sleeve 29 surrounding the body of the injector member. Injector 23 is correctly positioned in the circumferential direction by a locking cam 43 provided on sleeve 29 engaging with a corresponding recess in retaining member 44. After retaining member 44 has been mounted, the injector member may be electrically contacted by inserting contact rail 13. Individual contacting elements 27 assigned to the body of injector 23, which electrically actuate injector member 23, are provided on contact rail 13, i.e., in electrical contact with contact strips 38, 29, 40 accommodated therein. Once injector 23 has been premounted in this manner in integrated cover element 6, a function test may be carried out on this premounted structural unit prior to connecting cover element 6 to lower-shell-shaped intake manifold section 5. Functional testing of individual injectors 23 involves, for example, checking the latter's seal as well as its electrical actuating capability before it is finally mounted on the internal combustion engine.

Once cover element 6 and injectors 23 accommodated therein are functioning properly and are able to be electrically actuated by contact rail 13, cover section 16 on cover element 6 is joined to lower-shell-shaped intake manifold section 5 along parting line 17 by friction welding or another integral joining method suitable for fusing plastic material. Integrally joining cover section 16 to lower-shell-shaped intake manifold section 5 forms a permanent connection that is also sealed to the outside, thus preventing external air from entering the interior of intake line branch 2. Individual injectors 23 positioned in first mounting location 22 and in second mounting location 28 in cover element 6 are permanently fixed in place in cover element 6 by mounting them on cylinder head 41. Sleeve 29 surrounding the valve body of injector 23 is pressed by cylinder head 41 against collar 31 on retaining member 44 and against the part of second mounting location 28 on cover element 6 positioned diametrically opposed thereto. Injector 23 is pressed with constant pretensioning against annular collar 31, ensuring that sealing ring 24 accommodated in the area of collar 25 on injector 23 remains in opening 26 of fuel distributor pipe 8 so that electrical contact element 27 is sealed against penetrating fuel.

A fuel channel connected to valve opening 37, which discharges into intake pipe 33 in cylinder head 41 at a discharge location 46, is provided on cylinder head 41 of the internal combustion engine. Fuel 47 is injected in the flow channel connected to valve opening 37, while combustion air flows in the intake line branch. Downstream from discharge area 46, an air/fuel mixture 49, for example, reaches the particular combustion chamber of the internal combustion engine. Intake line section 2 is located between the intake manifold section and cylinder head 41 along a parting line 34 and is sealed by a sealing ring 35, which is insertable either into cylinder head 41 or into a flange corresponding thereto on lower shell 5 and cover section 16 of cover element 6 having integrated function groups, preventing external air from entering intake line branch 2 or an intake channel 50 within cylinder head 41. Downstream from discharge area 46, fuel 47 and intake combustion air 48 combine and flow to the combustion chamber of the internal combustion engine in the form of an air/fuel mixture 49.

An example embodiment of the present invention enables a fuel distributor pipe 8 to be integrated into cover element 6, which also includes a cover section 16, since both fuel distributor pipe 8 and cover section 16 of the cover element are made of a polyamide material (PA 66), thus taking advantage of material affinity. The example embodiment according to the present invention may considerably reduce the component variety that is necessary when separately mounting fuel distributor 8 in the intake tract area. Secondary wiring harnesses for individually actuating injectors 23, which are used according to the single-injection principle, may now be implemented by a contact rail 13 having a central connector 14, also encapsulating contacting elements 27 against the external effects of weather and contamination. In addition, the proposed object according to the present invention allows a function test of injectors 23 to be carried out at an early stage, enabling defective units to be replaced if necessary before cover element 6 is integrally joined to lower-shell-shaped intake manifold section 5.

Positionally accurate locking of injector 23 in the area of its second mounting location 28 in cover element 6 is made possible by retaining element 34. The latter presses sleeve 29 surrounding the body of injector 23 by its end face, which is diametrically opposed to valve opening 37, against a collar 31. A locking cam 43 holds injector member 23 in its circumferential position. For this purpose, sleeve 29 may be shrink-fitted onto the circumferential surface of injector 23 using a press fit.

List of Reference Characters

| a | Injector |
|---|---|
| b | Intake line |
| c | Distributor pipe |
| d | Secondary wiring harness |
| e | Retaining clip |
| f | Connector of secondary wiring harness |
| 1 | Intake tract |
| 2 | Intake line branch |
| 3 | Mounting flange |
| 4 | Hole |
| 5 | Lower shell of intake manifold section |
| 6 | Cover element having integrated function groups |
| 7 | Rib structure |
| 8 | Fuel distributor pipe |
| 9 | Longitudinal axis |
| 10 | Jacket surface |
| 11 | Locking element |
| 12 | Fuel inlet |
| 13 | Contact rail |
| 14 | Central connector |
| 15 | Contact tabs |
| 16 | Cover section of intake manifold section |
| 17 | Parting line |
| 18 | Mounting position of injector |
| 19 | Outer wall of fuel distributor pipe |
| 20 | Cavity |
| 21 | Inner wall of fuel distributor pipe |
| 22 | First mounting location of injector |
| 23 | Injector unit |
| 24 | Ring element |
| 25 | Collar |
| 26 | Hole |
| 27 | Contacting element |
| 28 | Second mounting location of injector |
| 29 | Sleeve of injector |
| 30 | Contact area |
| 31 | First collar |
| 32 | Second collar |
| 33 | Intake pipe of cylinder head |
| 34 | Parting line of intake manifold/cylinder head |
| 35 | Sealing ring of intake manifold/cylinder head |
| 36 | Seal |
| 37 | Valve opening |
| 38 | Contact strip |
| 39 | Contact strip |
| 40 | Contact strip |
| 41 | Cylinder head of internal combustion engine |
| 42 | Circumferential groove |
| 43 | Locking cam |
| 44 | Retaining member |
| 45 | Supporting surface of contact rail 13 |
| 46 | Discharge area |
| 47 | Fuel |
| 48 | Combustion air |
| 49 | Air/fuel mixture |
| 50 | Intake channel of cylinder head |

What is claimed is:

1. An intake tract for an internal combustion engine having a number of cylinders, comprising:
a plurality of intake line branches corresponding to the number of cylinders in the internal combustion engine that are mountable on the internal combustion engine in an intake area; and
a fuel distributor configured to supply fuel to at least one injector;
wherein the at least one injector and its mounting locations, and fuel supply components and their contacting elements are integrated into a cover element to be joined to a lower-shell-shaped intake manifold section.

2. The intake tract according to claim 1, wherein the cover element includes an integrated fuel distributor pipe and a cover section for covering the lower-shell-shaped intake manifold sections.

3. The intake tract according to claim 2, wherein the fuel distributor includes a number of openings corresponding to the number of injectors through which the fuel flows to the injectors.

4. The intake tract according to claim 1, wherein a first annular mounting location and a second shell-shaped mounting location for the injectors are injection-molded onto the cover element.

5. The intake tract according to claim 4, wherein one of the first and second mounting locations for the injectors includes annular collar surfaces on which the injectors are positioned.

6. The intake tract according to claim 2, wherein the fuel distributor pipe in the cover element is supported by an injection-molded rib structure.

7. The intake tract according to claim 2, wherein a fuel inlet is injection-molded onto a jacket surface of the fuel distributor pipe.

8. The intake tract according to claim 1, wherein the cover element accommodates a contact rail that extends parallel to a longitudinal axis of the fuel distributor pipe and contacts the injectors.

9. The intake tract according to claim 8, wherein a central connector is disposed on the contact rail and is connected to contact strips within the contact rail.

10. The intake tract according to claim 4, wherein the injectors includes annular sealing elements for the retaining element in the area of the first mounting location and in the area of the second mounting location.

11. The intake tract according to claim 1, wherein each injector is surrounded by sleeve-like envelope that includes a swelling for mounting a retaining element and a locking cam.

12. The intake tract according to claim 8, wherein the second mounting location includes a retaining member that surrounds the locking cam and on which is disposed a supporting surface for the contact rail.

13. The intake tract according to claim 1, wherein the cover element is an injection-molded plastic part.
